(19) United States
(12) Patent Application Publication
(10) Pub. No.: US 2023/0286598 A1
(43) Pub. Date: Sep. 14, 2023

(54) AERODYNAMIC SYSTEM, AND METHOD FOR CONTROLLING AN ADJUSTABLE AERODYNAMIC ELEMENT

(71) Applicant: ZF Friedrichshafen AG, Friedrichshafen (DE)

(72) Inventors: Stefan Beller, Friedrichshafen (DE); Matthias Wesa, Ravensburg (DE)

(73) Assignee: ZF Friedrichshafen AG, Friedrichshafen (DE)

(21) Appl. No.: 18/041,577

(22) PCT Filed: Jul. 15, 2021
(86) PCT No.: PCT/EP2021/069701

§ 371 Date: Feb. 14, 2023

(30) Foreign Application Priority Data
Aug. 14, 2020 (DE) 10 2020 210 362.3

(51) Int. Cl. B62D 35/00

(52) U.S. Cl. CPC B62D 35/002; B62D 35/007

(57) ABSTRACT

An aerodynamic system may have at least one adjustable aerodynamic element on a leading vehicle. The system may include a sensor device, which is located on the trailing vehicle and is configured to detect status information for the leading vehicle. The system also may include an evaluation unit that is configured to determine a target setting for the aerodynamic element on the basis of respective available settings for the aerodynamic element, the obtained status information, and an optimizing variable. A control unit in the system may be configured to adjust the aerodynamic element to the target setting. A method for controlling the adjustable aerodynamic element may also be included.

### RELATED APPLICATION(S)

This application is a filing under 35 U.S.C. § 371 of International Patent Application PCT/EP2021/069701, filed Jul. 15, 2021, and claiming priority to German Patent Application 10 2020 210 362.3, filed Aug. 14, 2020. All applications listed in this paragraph are hereby incorporated by reference in their entireties.

### TECHNOLOGICAL FIELD

The present invention relates to an aerodynamic system for two vehicles traveling such that one is trailing the other. The invention also relates to a method for controlling an adjustable aerodynamic element.

### BACKGROUND AND PRIOR ART

An important cost factor in the course of operating motor vehicles is fuel consumption. In particular in long distance travel at a substantially constant speed, air resistance, which increases quadratically as the speed increases, is of substantial importance. In addition to the design of the vehicle and the resulting CW value, the flow conditions generated by a leading vehicle can have a substantial effect on the actual air resistance. By way of example, when traveling in the wind shadow of another vehicle, the resistance encountered by the trailing vehicle can be substantially lowered.

A method for adjusting an airflow guide system on a vehicle in a platoon is described in WO 2019/068398. This involves reducing the air resistance of at least one vehicle in the platoon while taking the prevailing winds into account.

A motor vehicle is described in DE 10 2016 010 293 A1 that has an aerodynamic element and a sensor system. A sensor unit therein can obtain status data for leading and/or trailing vehicles. The position of the aerodynamic element is adjusted on the basis of the status data obtained with the sensor system. The sensor unit therein, which records data behind the leading vehicle, is complex.

### BRIEF DESCRIPTION OF THE INVENTION

A first aspect of the invention relates to an aerodynamic system for two vehicles that are traveling together, with one is trailing the other. These vehicles are motor vehicles in the form of trucks. The vehicles can contain a drive comprising an electric motor or an internal combustion engine. A truck can comprise a tractor and a trailer. When traveling together with one is trailing the other, this means that two vehicles are traveling in the same lane within a maximum spacing, and without another vehicle between them. The vehicles can be designed for autonomous driving. The trailing vehicle can follow the leading vehicle autonomously. The two vehicles travel at substantially the same speed and maintain a constant distance to one another while the aerodynamic system is in use.

The aerodynamic system can contain at least one adjustable aerodynamic element. The aerodynamic element be located on the leading vehicle. By way of example, the aerodynamic element can be part of the leading vehicle. This aerodynamic element can act on the airflow in the course of travel, depending on its setting. The aerodynamic element can be an airflow guide element, for example, such as an adjustable airflow guide plate. In particular, it can be a rear spoiler on the leading vehicle. The aerodynamic element can also be an adjustable airflow channel in the vehicle's body that can be opened and closed. The aerodynamic element can also be an element that actively acts on the airflow, such as a propeller, in which case it can either be “activated” or “deactivated.” A change in shape of the aerodynamic element by an actuator can also be regarded as an adjustment.

The aerodynamic system can contain a sensor device. The sensor device can be located on the trailing vehicle. The sensor device can be designed to obtain data at least regarding the status of the leading vehicle. The range of the sensor device can comprise the area in front of the trailing vehicle. By way of example, the sensor device can contain a camera pointing forwards. With an autonomous vehicle, the sensor device can also be used for the autonomous driving. The sensor data can therefore be used for controlling the trailing vehicle with the sensor device and for adjusting the aerodynamic element. This eliminates the need for any additional sensors. In particular, there is no need for an additional sensor on the leading vehicle pointing backwards. This results in a particularly simple and inexpensive system. This is particularly convenient with trucks, because the trailers are frequently exchanged therewith. It is therefore not necessary to equip each trailer with these sensors, and then connect these sensors to the tractor. Furthermore, the sensor devices can obtain the status information directly for the leading vehicle in a platoon, which substantially affects the airflow conditions. This makes it easier to adjust the aerodynamic element more precisely to its target setting.

The aerodynamic system can contain an evaluation unit. The evaluation unit can be configured to determine a target setting for the aerodynamic element on the basis of the respective available settings of the aerodynamic element, the acquired status information, and an optimizing variable. The target setting can result in an improvement on the value of the optimizing variable, in particular resulting in a best possible value for the optimizing variable. The target setting can maximize or minimize the value of the optimizing variable when the boundary conditions otherwise remain unchanged. By way of example, the rolling resistance of one of the vehicles and/or fuel consumption can form the optimizing variable. The setting of the aerodynamic element can have an effect on the optimizing variable. Respective available settings for the aerodynamic element can correspond to the range of positions of the aerodynamic element, e.g. its range of angular motion. The target setting can be a setting of the aerodynamic element that differs from the current setting.

The evaluation unit can be located on one of the two vehicles, or it can form a central server. The central server can be provided by a computing center, for example. The aerodynamic system can contain a signal transmission system designed for radio communication between the two vehicle and/or a central server. The signal transmission system can be configured to transmit the respective available settings for the aerodynamic element to the evaluation unit. By way of example, the signal transmission system can transmit possible settings of the adjustment angle. This configuration of the signal transmission system is ideal when the evaluation unit is part of the trailing vehicle or forms a central server. The signal transmission system can also be configured to transmit at least status information to the evaluation unit. This configuration of the signal transmission system is useful if the evaluation unit is part of the leading vehicle or forms a central server. The signal transmission system can comprise a V2X interface, for example, and/or make use of a cellular telephone network. The signal transmission system can comprise transmitters and receivers on the vehicles and/or for a central server, depending on the intended direction of data transmission.

The aerodynamic system can comprise a control unit. The control unit can be configured to adjust the aerodynamic element to the target setting. This improves the optimizing variable. The control unit can be functionally connected to the aerodynamic element and/or contain respective actuators for this. The target setting can be transmitted from the evaluation unit to the control unit, e.g. by means of the signal transmission system or a connecting cable.

The aerodynamic element can also contain numerous adjustable aerodynamic elements, e.g. a roof spoiler, and two side spoilers. A target setting can be determined for each aerodynamic element on the basis of the optimizing variable and available settings, and be set by the control unit. When a single aerodynamic element is referred to in the following, this can also apply to numerous aerodynamic elements, if applicable.

In another design of the aerodynamic system, the evaluation unit can be configured to select the optimizing variable on the basis of the energy storage level in one of the two vehicles. The energy storage can be a fuel tank or a battery that supplies electricity to the vehicle's drive unit. The energy storage level can thus refer to the remaining fuel in the fuel tank, or the electricity that can be supplied by the battery for forward travel. This makes it possible to optimize fuel consumption as needed by adjusting the aerodynamic element. By way of example, fuel consumption of a vehicle with a low energy supply can be optimized, in particular if the energy supply would otherwise not be enough to reach a target destination.

In another embodiment of the aerodynamic system, the optimizing variable can be selected from a list that contains the fuel consumption of the leading vehicle, fuel consumption of the trailing vehicle, and the combined fuel consumption for both vehicles. The fuel consumption of the trailing vehicle can be reduced, for example, by enlarging the wind shadow through the adjustment of the aerodynamic element. This may involve an increase in the air resistance for the leading vehicle, such that this optimizing variable may be ideal specifically if the energy storage level in the trailing vehicle is low.

The fuel consumption of the leading vehicle can be reduced by improving its air resistance through an adjustment of the aerodynamic element. This optimizing variable may be better if increasing the air resistance of the leading vehicle is not compensated for by the decrease in air resistance for the trailing vehicle, e.g. in the form of a reimbursement. The combined fuel consumption of the two vehicles can be regarded as the fuel consumption for a fleet. The combined fuel consumption can be the total energy consumption for forward travel. The combined fuel consumption of the two vehicles can be optimized, for example, for purposes of environmental protection if both vehicles belong to a single operator, or compensation is paid accordingly. This optimizing variable may be ideal if the increase in the air resistance for the leading vehicle can be more than compensated for by the corresponding reduction in air resistance for the trailing vehicle, e.g. by traveling in the wind shadow. The fuel consumption can comprise the amount of electricity and/or fuel consumed per unit of travel or over time. The selection can be made once, resulting in a permanent design of the system in relation to the corresponding optimizing variable. The optimizing variable can also be dynamic, based on measurement values and/or boundary conditions, in order to obtain an advantageous optimization for the user of the system, depending on the current situation.

In another embodiment of the aerodynamic system, if the available energy in an energy storage falls below a minimum fuel supply level in one of the two vehicles, the fuel consumption of this vehicle is selected as the optimizing variable. As a result, the fuel consumption efficiency in the vehicle with lower energy reserves can be increased. Consequently, the distance that a fleet can travel to a target destination or fuel station, in which the vehicles are close together and the aerodynamic elements are adjusted accordingly, can be increased over that of a single vehicle. The trailing vehicle is basically towed along by the wind shadow obtained with the adjustment of the aerodynamic elements. The minimum fuel supply level can be predefined value, e.g. 20%. The minimum fuel supply level can also be defined by the evaluation unit on the basis of the remaining distance to be travelled, e.g. to the next filling station along a planned route, or a target destination. Optionally, the current fuel consumption can also be taken into account by the evaluation unit. Minimum fuel supply levels for both vehicles can also be taken into account in the selection. By way of example, fuel consumption can be optimized in one vehicle by adjusting the aerodynamic elements only if the energy storage level in the other vehicle is also above another minimum fuel supply level. This prevents the leading vehicle from not otherwise being able to reach its target destination or the next filling station. This other minimum fuel supply level can also be predefined, or defined on the basis of a planned route or target destination.

In another embodiment of the aerodynamic system, the sensor device can be configured to detect at least one of the following values for the leading vehicle as the status information thereof: speed, distance to trailing vehicle, height, width, silhouette, and alignment in relation to a driving lane. The silhouette can be a contour, for example, that can be detected by the sensor device. By way of example, the status information can also comprise numerous, or all, of these values. The effect on the air resistance for the trailing vehicle can be effectively determined on the basis of these values. In particular, a wind shadow can be precisely calculated on the basis of these values. Furthermore, these values can be obtained easily by sensors pointed toward the front in the trailing vehicle, in particular sensors that otherwise obtain information for autonomous driving of the trailing vehicle.

In another embodiment of the aerodynamic system, the sensor device can comprise at least one of the following components: an ADAS sensor set, a camera pointed toward the front, a radar system, an ultrasonic sensor system, or a lidar. An ADAS sensor set is a set of sensors for autonomous or semiautonomous driving of the trailing vehicle. The sensor device can also comprise numerous, or all of these components. The radar system and the ultrasonic sensor system can contain respective transmitters for transmitting radar or ultrasonic waves, and respective receivers for receiving the reflected waves. The radar system can be configured for long, medium, or short ranges, for example.

In another embodiment of the aerodynamic system, the evaluation unit can be configured to determine the fuel consumption of the leading vehicle and the trailing vehicle for the available settings of the aerodynamic elements on the basis of the status information and the respective available settings. The evaluation unit can determine values stored in tables for this, for example, or simulate air resistances for both vehicles. The fuel consumption of each of the two vehicles for relevant parameters can be stored in the table, for example. Other information can also be provided to the evaluation unit for the determination, e.g. information regarding respective aerodynamics and drive trains for one or both of the vehicles. The information can be stored in a central server, or locally in the vehicles. The information can be transmitted to the evaluation unit by the signal transmission system.

In another embodiment of the aerodynamic system, the evaluation unit can be configured to determine the wind shadow of the leading vehicle on the basis of the status information and the respective available settings of the aerodynamic elements, and determine the fuel consumption of the trailing vehicle on the basis of the wind shadow. The wind shadow resulting from a setting of the aerodynamic element can be determined from just the status information obtained the sensor device on the trailing vehicle and information regarding the respective available settings of the aerodynamic elements, without necessarily having to have more information regarding the leading vehicle. This means that the necessary data exchange can be small. By way of example, only one adjustment command is sent from the trailing vehicle to the evaluation unit in the leading vehicle by the signal transmission system in one embodiment. Moreover, a trailer that has the adjustable aerodynamic element can also then be used with different tractors, for example, without the tractor having to satisfy special requirements, or information regarding the tractor having to be stored. The wind shadow can be zone in which the air speed is lower on a downwind side of the leading vehicle. The downwind can be defined by the slipstream of the leading vehicle and also a vectorial addition of this slipstream and the ambient wind.

In another embodiment of the aerodynamic system, the evaluation unit can be configured to obtain a value for the optimizing variable and to determine the target setting in an adaptive manner. The evaluation unit can have a sensor for this. By way of example, the evaluation unit can be configured to detect the fuel consumption of the trailing vehicle, or receive data in this regard, in particular by means of the signal transmission system. The adaptive determination of the target setting can take place through trial-and-error. In this case, the setting of the aerodynamic element is altered slightly, in order to detect the effect of the change on the value of the optimizing variable. A regional or global maximum or minimum for the optimizing variable can be set in this manner. Respective curves or graphs for the available settings of the aerodynamic element can also be generated in this manner. These can be reused for identical combinations of leading and trailing vehicles. Respective curves and graphs can be stored in the evaluation unit, for example. Furthermore, the respective environmental effects in the current driving situation, e.g. side winds, can also be taken into account in these curves or graphs, even without having to detect them with a sensor, for example.

In another embodiment of the aerodynamic system, the aerodynamic element can be formed by a rear spoiler, the angle of which can be adjusted. A rear spoiler can be an airflow guide element that projects upward from the leading vehicle, and forms an airflow deflection surface. A rear spoiler can be used particularly effectively to deflect the airflow on a vehicle, and thus affect its wind shadow. The adjustment angle can be the angle between a surface of the rear spoiler substantially facing the direction of travel and the slipstream or direction of travel. By way of example, the rear spoiler can be tilted up or down in order to vary the adjustment angle.

A second aspect of the invention relates to a method for controlling an adjustable aerodynamic element in the case of two vehicles traveling together, with one trailing the other, where the leading vehicle has the aerodynamic element. The method can be configured to be carried out with the aerodynamic system described with regard to the first aspect of the invention. The advantages and features obtained with the first aspect are also advantages and features of the second aspect, and vice versa.

The method can contain a step for obtaining at least status information for the leading vehicle with a sensor device on the trailing vehicle. The method can contain a step for determining a target setting for the aerodynamic element on the basis of the available settings for the aerodynamic element, the status information, and an optimizing variable. The method can contain a step for adjusting the aerodynamic element to the target setting. It may also be intended in the method that the trailing vehicle automatically follows the leading vehicle, e.g. with the use of an autonomous driving system. The leading vehicle can also be autonomous in the framework of the method. A prerequisite for carrying out the method can be that the trailing vehicle follows the leading vehicle at a distance that is shorter than a minimum distance thereto, and/or that there are no other vehicles between the two.

In another embodiment of the method, the status information can be transmitted to an evaluation unit that then determines the setting for the aerodynamic element on the basis of the available settings and the optimizing variable. The status information can be transmitted to the leading vehicle or a central server, depending on the design of the evaluation unit, e.g. through radio signals. For the signal transmission, the trailing vehicle only needs a transmitter for the signal transmission system and the sensor device. The sensor device may already be incorporated in the vehicle for the autonomous driving function, and a V2X interface used for other functions can be used for the data transfer.

In another embodiment of the method, the available settings for the aerodynamic element can be transmitted to an evaluation unit that then determines the target setting for the aerodynamic element on the basis of the available settings and the optimizing variable. The leading vehicle then does not have to determine the target setting. By way of example, the evaluation necessary for this can take place in a central server that can provide the necessary computing more cost-effectively. By way of example, the target setting can be determined in the trailing vehicle, so that it is not necessary to transmit a large amount of data in the form of status information obtained with the sensor device. In this case, the signal transmission system only needs to be able to transmit the target setting to the control unit.

In another embodiment of the method, the optimizing variable can be selected from a list containing the fuel consumption of the leading vehicle, the fuel consumption of the trailing vehicle, and the combined fuel consumption for the two vehicles. The optimizing variable can be selected such that the aerodynamic element can be set automatically to obtain the desired fuel consumption optimization.]

In another embodiment of the method, the optimizing variable can be selected on the basis of an energy storage level in at least one of the two vehicles. The optimizing variable can then be selected automatically in relation to the energy storage level in question.

### BRIEF DESCRIPTION OF THE DRAWINGS

FIG. 1 shows a schematic illustration of an aerodynamic system.

FIG. 2 shows a schematic illustration indicating the status information that can be obtained with the sensor device in the aerodynamic system shown in FIG. 1.

FIG. 3 shows a schematic illustration of a method for controlling an adjustable aerodynamic element in the aerodynamic system shown in FIG. 1.

### DETAILED DESCRIPTION OF THE DRAWINGS

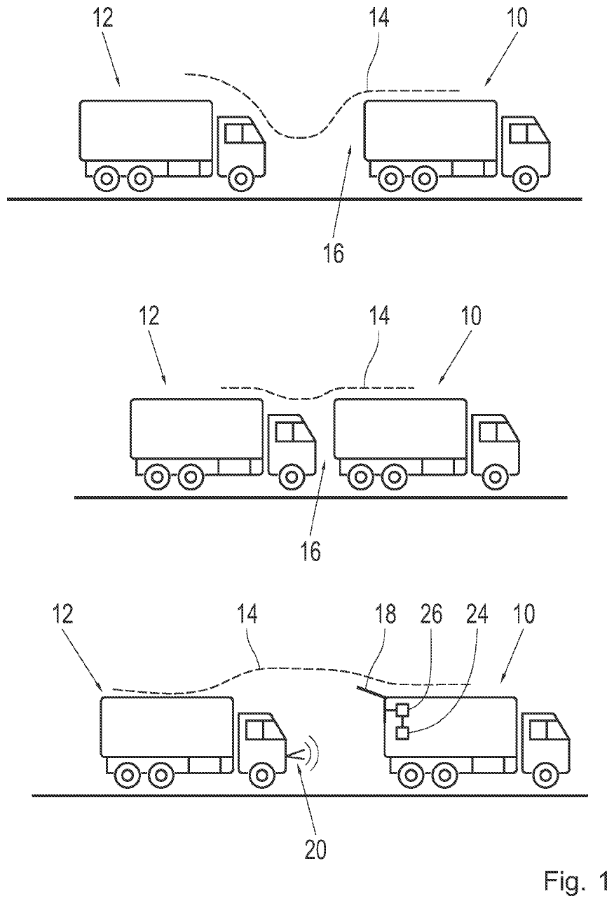

FIG. 1 shows a schematic illustration of an aerodynamic system. The illustration shows a leading vehicle 10 and a trailing vehicle 12, both of which are trucks. Both vehicles 10, 12 are traveling forwards. A wind shadow 16 is created by an airflow caused by the leading vehicle 10, indicated by the broken line 14, and a slipstream. The wind shadow 16 is an area with lower wind speed.

The two vehicles 10, 12 are traveling at a distance to one another the upper third of FIG. 1, in which the trailing vehicle 12 is outside the wind shadow 16. The front end of the trailing vehicle 12 is driving into the airflow, and thus subjected to a stronger air resistance. This results in a higher fuel consumption for the trailing vehicle 12.

The middle part of FIG. 1 shows the two vehicles 10, 12 traveling at a distance to one another in which the front end of the trailing vehicle 12 is largely within the wind shadow 16. As the broken line 14 illustrating the airflow indicates, the airflow is substantially above the trailing vehicle 12, and no longer impacts the front end for the most part. This results in a lower air resistance for the trailing vehicle 12, such that its fuel consumption is reduced.

This spacing between the vehicles 10, 12 can be obtained by “platooning,” also referred to as an “electronic drawbar.” The two vehicles 10, 12 are operated at least semiautonomously in this case. If the leading vehicle 12 has to slow down slightly, however, the trailing vehicle 12 needs to make larger speed adjustments due to the short distance between the two vehicles 10, 12, e.g. by braking strongly. This satisfies requirements regarding traffic safety, although platooning is still more risky.

It is therefore desirable to be able to obtain the aerodynamic advantages obtained with the spacing shown in the middle, but with a greater distance between the two vehicles 10, 12. The leading vehicle 10 therefore has an adjustable aerodynamic element 18 on top of its trailer for this. The aerodynamic element 18 forms a rear spoiler. When the aerodynamic element 18 is raised, it lifts the airflow at the rear of the leading vehicle 10, as indicated by the broken line 14 in the lower third of FIG. 1. In this embodiment, the aerodynamic element 18 is attached to the trailer with a hinge. In another embodiment, the aerodynamic element 18 can slide up and down.

It can be seen in the lower third of FIG. 3 that the airflow now lies largely above the trailing vehicle 12. This results in better airflow conditions than in the state shown in the middle of FIG. 1, in which the aerodynamic element 18 is retracted, and lies flat against the leading vehicle 10. Nearly all of the front end of the trailing vehicle 12 is now in the enlarged wind shadow 16 obtained with the aerodynamic element 16. The fuel consumption of the trailing vehicle 12 is substantially reduced in this manner. The savings in terms of fuel consumption are greater than the increase in fuel consumption caused by the deployment of the aerodynamic element 18 and the resulting air resistance for the leading vehicle 10, thus resulting in a greater overall efficiency for the two vehicles obtained with this form of platooning. The silhouette of the trailing vehicle 12 does not need to be altered to obtain these advantages. The increase in efficiency can be obtained by trailing at a defined distance, controlled in this case by the autonomous driving system in the trailing vehicle 12.

The aerodynamic element 18 is set with respect to the external dimensions of the two vehicles 10, 12. By way of example, if the trailing vehicle 12 is smaller than the leading vehicle 10, the aerodynamic element 18 does not have to be raised as far to obtain a beneficial airflow, so that the air resistance for the leading vehicle 10 does not need to be enlarged unnecessarily. If the trailing vehicle 12 is larger than the leading vehicle 10, the aerodynamic element is raised higher, in order to obtain a larger increase in efficiency. The distance between the two vehicles 10, 12 can also be taken into account. By way of example, the aerodynamic element 18 is first raised when the distance between the two vehicles 10, 12 falls below a minimum spacing, because the increase in efficiency an only be obtained if the vehicles are close enough together.

The efficiency can be further increased by this means. The trailing vehicle 12 has a sensor device 20 for this. The detection region of the sensor device 20 is pointing forwards. The sensor device 20 makes use of the same sensors that are also used for generating the data necessary for the autonomous driving system in the trailing vehicle 12.

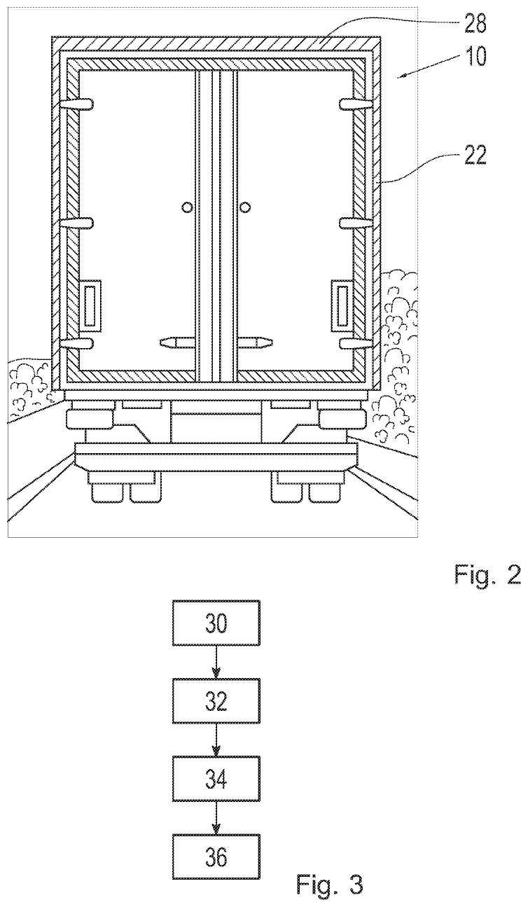

FIG. 2 shows a schematic illustration indicating the status information that can be obtained with the sensor device 20. The sensor device measures the height 22 and width of the leading vehicle 10. In one embodiment, the overall shape or silhouette thereof is detected. The distance between the two vehicles 10, 12 is also detected, as well as their positions on the road. These values form the status information, although other embodiments may contain more or fewer values.

This status information is sent to an evaluation unit 24. In the present case, the evaluation unit 24 is in the leading vehicle 10. The data transfer is made with a radio signal connection for this reason, using a signal transmission system, which is not indicated in the drawing. In another embodiment, the evaluation unit is in the trailing vehicle 12, in which case the data transfer can take place with a hard-wired connection, and the signal transmission system simply sends a target setting to the leading vehicle 10, or its control unit 26. In yet another embodiment, the evaluation unit is in the form of a central server, to which the status information is sent via a cellular telephone network, for example.

Available settings for the aerodynamic element 18 are stored in the evaluation unit 24, or are sent thereto. The respective data for the trailing vehicle 12, such as its height, width and shape, are also stored in the evaluation unit 24, or sent thereto. The data can also contain information from the autonomous driving system, such as the next driving maneuver, a traffic strategy, and information regarding other road users. A target stetting for the aerodynamic element 18 is then determined by the evaluation unit 24 on the basis of this data, the detected status information, and the available settings for the aerodynamic element 18, as well as an optimizing variable. The optimizing variable is selected in this case on the basis of the fuel consumption of the trailing vehicle 12, the fuel consumption of the leading vehicle 10, or a combined fuel consumption of the two vehicles 10, 12. One of these fuel consumption values can then be optimized by an optimized setting of the angle of the aerodynamic element 18 for a specific situation. This is accomplished with the control unit 26, which is configured to adjust the aerodynamic element 18 to the target setting.

Certain driving situations can also be taken into account by the aerodynamic system when setting the aerodynamic element 18. If the leading vehicle is tilting from side to side, or hydroplaning, the aerodynamic element 18 is not raised. Otherwise, the leading vehicle 10 would be slowed down by the increased air resistance. The trailing vehicle 12 would then have to slow down in order to maintain its distance and reduced air resistance obtained with the improved airflow.

The method for controlling the adjustable aerodynamic element 18 when two vehicles 10, 12 are travelling together, with one trailing the other. The respective status information for the leading vehicle 10 is obtained by a sensor device 20 on the trailing vehicle 12 in the first step 30. The optimizing variable is selected on the basis of an energy storage level in the two vehicles 10, 12 in the second step 32. This selection can also be made by the evaluation unit 24. If the energy storage level in the trailing vehicle 12 lies below a threshold value, and that in the leading vehicle 12 is above a threshold level, the fuel consumption of the trailing vehicle 12 is selected as the optimizing variable. As a result, it is possible to still reach a target destination with limited energy reserves, e.g. in the form of fuel or electricity, through fuel consumption optimization. If the energy storage levels in both vehicles 10, 12 are above a threshold value, the combined fuel consumption of both vehicles 10, 12 is selected as the optimizing variable. The makes it possible to travel particularly efficiently, as long as both energy storage levels are sufficient for reaching a desired target destination. The target setting of the aerodynamic element 18 is determined in the third step 34 on the basis of the respective available settings for the aerodynamic element 18, the detected status information, and the selected optimizing variable. The aerodynamic element 18 is adjusted to the target setting in the fourth step 36.

### REFERENCE SYMBOLS

10 leading vehicle
12 trailing vehicle
14 line/airflow
16 wind shadow
18 aerodynamic element
20 sensor device
22 height
24 evaluation unit
26 control unit
28 width
30 step
32 step
34 step
36 step

1. An aerodynamic system for two vehicles travelling such that a trailing vehicle is trailing a leading vehicle, comprising:
at least one adjustable aerodynamic element located on the leading vehicle;
a sensor device, located on the trailing vehicle and configured to at least detect status information for the leading vehicle;
a evaluation unit, configured to determine a target setting for the aerodynamic element on the basis of the respective available settings for the aerodynamic element, the detected status information, and an optimizing variable; and
a control unit, configured to adjust the aerodynamic element to the target setting.

2. The aerodynamic system according to claim 1, wherein the evaluation unit is configured to select the optimizing variable on the basis of an energy storage level in at least one of the two vehicles.

3. The aerodynamic system according to claim 1, wherein the optimizing variable is selected from a list containing fuel consumption for the leading vehicle, fuel consumption for the trailing vehicle, and the combined fuel consumption for both vehicles.

4. The aerodynamic system according to claim 3, wherein if a level in the energy storage level falls below a minimum fuel supply level in one of the two vehicles, the fuel consumption for this vehicle is selected as the optimizing variable.

5. The aerodynamic system according to claim 1, wherein the sensor device is configured to detect at least one of the following values as status information for the leading vehicle: speed, distance to the trailing vehicle, height, width, silhouette, and alignment in relation to a driving lane.

6. The aerodynamic system according to claim 1, wherein the sensor device contains at least one of the following components: an ADAS sensor set, a camera facing forwards, a radar system, an ultrasonic sensor, or a lidar.

7. The aerodynamic system according to claim 1, wherein the evaluation unit is configured to determine the fuel consumption for the leading vehicle and the trailing vehicle resulting from the available settings on the basis of the status information and the respective available settings for the aerodynamic element.

8. The aerodynamic system according to claim 7, wherein the evaluation unit is configured to determine a wind shadow of the leading vehicle on the basis of the status information and the respective available settings for the aerodynamic element, and determine the fuel consumption for the trailing vehicle on the basis of the wind shadow.

9. The aerodynamic system according to claim 1, wherein the evaluation unit is configured to obtain a value for the optimizing variable, and to determine the target setting in an adaptive manner.

10. The aerodynamic system according to claim 1, wherein the aerodynamic element is formed by a rear spoiler, the angle of which can be adjusted.

11. A method for controlling an adjustable aerodynamic element when two vehicles are traveling together such that a trailing vehicle is trialing a leading vehicle, wherein the leading vehicle has the aerodynamic element, the method comprising at least the following steps:
obtaining status information for the leading vehicle with a sensor device on the trailing vehicle;
determining a target setting for the aerodynamic element on the basis of the respective available settings for the aerodynamic element, the detected status information, and an optimizing variable; and
adjusting the aerodynamic element to the target setting.

12. The method according to claim 11, wherein the status information is sent to an evaluation unit, which determines the target setting for the aerodynamic element on the basis of the available settings and the optimizing variable.

13. The method according to claim 11, wherein the available settings for the aerodynamic element are sent to an evaluation unit, which determines the target value for the aerodynamic element on the basis of the available settings and the optimizing variable.

14. The method according to claim 11, wherein the optimizing variable is selected from a list, which contains the fuel consumption of the leading vehicle, fuel consumption of the trailing vehicle, and the combined fuel consumption for the two vehicles.

15. The method according to claim 14, wherein the optimizing variable is selected on the basis of an energy storage level in at least one of the two vehicles.
